(19) United States
(12) Patent Application Publication
(10) Pub. No.: US 2013/0025894 A1
(43) Pub. Date: Jan. 31, 2013

(54) TOOL HAVING TORQUE-CONTROLLED SPINDLE LOCK ASSEMBLY

(71) Applicant: David C. Campbell, Bel Air, MD (US)

(72) Inventor: David C. Campbell, Bel Air, MD (US)

(73) Assignee: BLACK & DECKER INC., Newark, DE (US)

(21) Appl. No.: 13/557,477

(22) Filed: Jul. 25, 2012

Related U.S. Application Data
(60) Provisional application No. 61/513,534, filed on Jul. 30, 2011.
(60) Provisional application No. 61/522,489, filed on Aug. 11, 2011.

(51) Int. Cl. B23B 31/02; B23Q 17/00

(52) U.S. Cl. 173/20; 173/216

(57) ABSTRACT

A hand-held power tool can include a housing, a motor assembly, and a spindle lock assembly. The housing can include a gear case. The motor assembly can be disposed in the housing and be configured to output rotary power to an output spindle. The spindle lock assembly can include an anvil matingly engaged to the output spindle. A ring structure can be rotatably received in the gear case and have a ring body and a reaction tab. A biasing member can be disposed in the gear case and configured to bias the reaction tab in a first predetermined rotational direction.

### CROSS-REFERENCE TO RELATED APPLICATIONS

This application claims the benefit of U.S. Provisional Application Nos. 61/513,534, filed on Jul. 30, 2011 and 61/522,489, filed on Aug. 11, 2011. The entire disclosures of each of the above applications are incorporated herein by reference.

### FIELD

The present disclosure relates generally to a drill chuck for use with a power drill and more specifically, to an indicator mechanism incorporated on the drill chuck that provides feedback to a user that an acceptable level of input tightening torque has been applied to the chuck.

### BACKGROUND

This section provides background information related to the present disclosure which is not necessarily prior art.

Drill chucks can be used in conjunction with power drills for releasably engaging various tools, such as drill bits and the like. Conventional drill chucks can also require a special tool for tightening and loosening the drill chuck onto the tool. Recently, drill chucks have been designed to be tightened by hand wherein a user can rotate a chuck sleeve of the drill chuck to cause the jaws of the drill chuck to engage and disengage the tool. The user of the power tool must rotate the adjustable chuck sleeve with one hand while holding a tool inside the jaw members until the tool is locked in place. In some examples, it may be difficult for a user to ascertain whether the tool has been sufficiently clamped.

### SUMMARY

This section provides a general summary of the disclosure, and is not a comprehensive disclosure of its full scope or all of its features.

A hand-held power tool can include a housing, a motor assembly, and a spindle lock assembly. The housing can include a gear case. The motor assembly can be disposed in the housing and be configured to output rotary power to an output spindle. The spindle lock assembly can include an anvil matingly engaged to the output spindle. A ring structure can be rotatably received in the gear case and have a ring body and a reaction tab. A biasing member can be disposed in the gear case and configured to bias the reaction tab in a first predetermined rotational direction. Rotation of the output spindle in a second rotational direction, opposite the first rotational direction rotates the ring structure about the output spindle causing the reaction tab to compress the biasing member. The spindle lock assembly inhibits further rotation of the output spindle in the second rotational direction.

According to additional features, the output planet carrier can form an output member of a transmission assembly. The transmission assembly can be selectively coupled between the motor assembly and the output spindle. The spindle lock assembly can further comprise a plurality of lugs coupled to an extending axially and outwardly from the output planet carrier. The lugs can define a plurality of lug drive surfaces. The anvil can define a plurality of anvil drive surfaces. Each of the lug drive surfaces can be disposed adjacent to an anvil drive surface.

According to still other features, a plurality of pins can be received in a corresponding gap defined between adjacent anvil drive surfaces. The biasing member can comprise a coil spring disposed in a groove defined in the gear case. Rotation of the output spindle can cause the anvil to rotate relative to the lugs such that the second drive surface of the anvil engages the pins against the ring body. The ring structure can comprise an indicator on a distal end of the reaction tab and that extends into a window in the gear case when the ring structure has been rotated a predetermined amount. The power tool can further comprise a braking means configured to inhibit rotation of the ring structure relative to the gear case. The braking means can comprise a brake element that is biased into frictional engagement with the ring structure.

A hand-held power tool constructed in accordance to additional features of the present disclosure can include a housing, a motor assembly, a nose cover and a spindle lock assembly. The housing can include a gear case. The motor assembly can be disposed in the housing and be configured to output rotary power to an output spindle. The nose cover can define at least one groove. The spindle lock assembly can include an anvil matingly engaged to the output spindle. A ring structure can be rotatably received in the gear case and have a ring body and at least one spoke. A detent can be disposed in the gear case and be configured to move upon rotation of the at least one spoke in a rotational direction. Rotation of the output spindle in the rotational direction can rotate the ring structure about the output spindle causing the at least one spoke to move the detent wherein the at least one spoke subsequently further rotates into the at least one groove.

According to additional features, the power tool can further comprise an output planet carrier that forms an output member of a transmission assembly. The transmission assembly can be selectively coupled between the motor assembly and the output spindle. The spindle lock assembly can further comprise a plurality of lugs coupled to and extending axially and outwardly from the output planet carrier. The lugs can define a plurality of lug drive surfaces. The anvil can define a plurality of anvil drive surfaces. Each of the lug drive surfaces can be disposed adjacent to an anvil drive surface.

According to one example, the detent can comprise an extension disposed on the at least one spoke and a coil spring disposed in a groove defined in the gear case. The coil spring can be configured to buckle and move into a deflected position.

According to other features, the detent can comprise a leaf spring disposed in a pocket of the nose cover of the power tool. The leaf spring can be configured to buckle and move into a deflected position. The leaf spring can comprise a C-shaped leaf spring having an end portion configured to nest into a spoke groove formed on the at least one spoke. The spring can be configured to be urged by an extension portion formed on the at least one spoke causing the spring to ride over a detent bump extending from the nose cover causing the spring to collapse.

According to another configuration, the detent can comprise a cam incorporated on the at least one spoke and configured to advance a roller past a detent pocket of the nose cover of the power tool.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevation view of an exemplary tool constructed in accordance with the teachings of the present disclosure;

FIG. 2 is an exploded perspective view of a portion of the tool of FIG. 1 illustrating a portion of the transmission assembly and the spindle lock assembly in greater detail;

FIG. 3 is a longitudinal section view of a portion of the tool of FIG. 1;

FIG. 4 is a section view of a portion of the tool of FIG. 1 taken through the line 4-4 of FIG. 3;

FIG. 5 is a side view of an exemplary tool constructed in accordance with the teachings of the present disclosure;

FIG. 6 is an exploded perspective view of a portion of the tool of FIG. 5 illustrating a portion of a transmission assembly and spindle lock assembly in greater detail;

FIG. 7 is an end view of a transmission housing nose cover of the tool of FIG. 5 that incorporates a mechanical detent configured in accordance to one example of the present teachings;

FIG. 8 is an end view of a transmission housing nose cover of the tool of FIG. 5 that incorporates a mechanical detent according to a second configuration of the present teachings;

FIG. 9 is an end view of a transmission housing nose cover of the tool of FIG. 5 that incorporates a mechanical detent according to a third example of the present teachings;

FIG. 9A is an end view of the transmission housing nose cover of the tool of FIG. 9 that incorporates an elastic element according to additional features;

FIG. 10 is an end view of a transmission housing nose cover of the tool of FIG. 5 that incorporates a mechanical detent according to a fourth configuration of the present teachings; and

FIG. 11 is an end view of a transmission housing nose cover of the tool of FIG. 5 that incorporates a mechanical detent according to a fifth configuration of the present teachings.

Corresponding reference numerals indicate corresponding parts throughout the several views of the drawings.

### DETAILED DESCRIPTION

Example embodiments will now be described more fully with reference to the accompanying drawings.

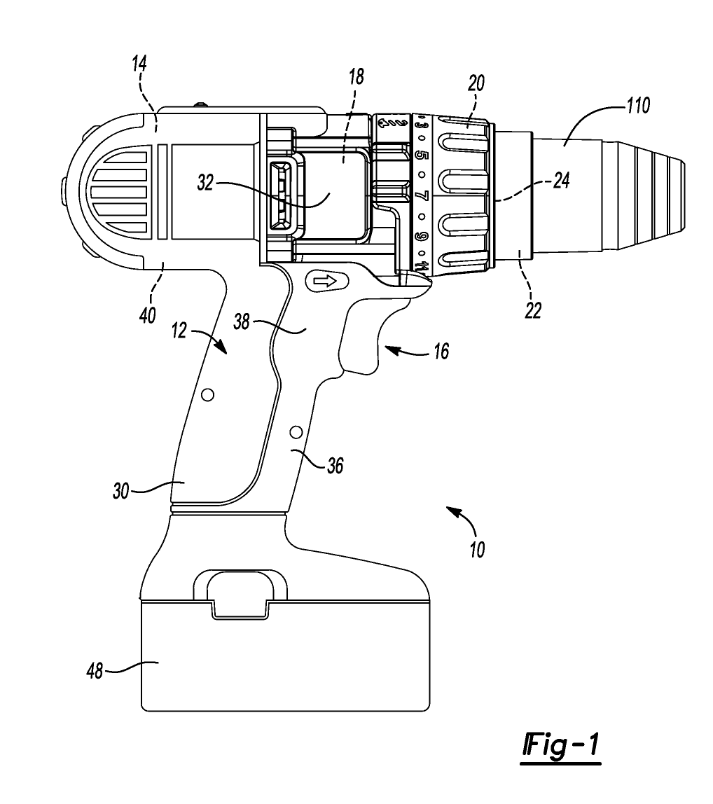

With reference to FIG. 1, an exemplary hand-held power tool constructed in accordance with the teachings of the present disclosure is generally indicated by reference numeral 10. The tool 10 can include a housing assembly 12, a motor assembly 14, a trigger assembly 16, a transmission assembly 18, a clutch assembly 20, an output spindle 22 and a spindle lock assembly 24.

The housing assembly 12 can comprise a pair of handle housing shells 30 and a gear case 32 that can be removably coupled to the handle housing shells 30 via a plurality of threaded fasteners (not shown). The handle housing shells 30 can cooperate to define a handle 36, a trigger mount 38, and a cavity 40 into which the motor assembly 14 can be received.

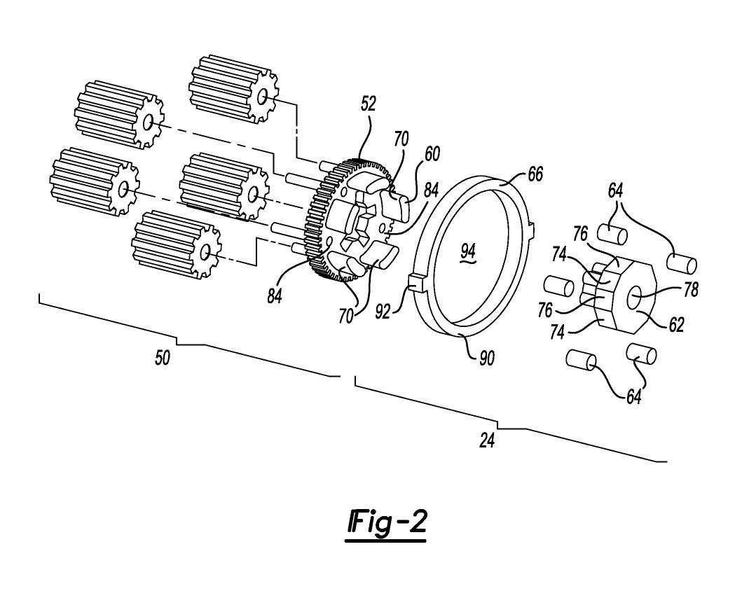

The motor assembly 14 the trigger assembly 16 and the clutch assembly 20 can be conventional in their construction and operation. In brief, the motor assembly 14 can provide rotary power to the transmission assembly 18, which can perform a speed reduction and torque multiplication function and can output rotary power to the output spindle 22. It will be appreciated that the transmission assembly 18 could be a multi-speed transmission that is selectively operable in two or more overall gear reduction ratios. The trigger assembly 16 can be mounted to the trigger mount 38 and can be employed to selectively couple the motor assembly 14 to a source of power, such as a battery pack 48. The clutch assembly 20 can be employed to limit the magnitude of the torque that is transmitted to the output spindle 22. In the particular example provided, the transmission assembly 18 comprises an output planetary stage 50 (partly shown in FIG. 2) having an output planet carrier 52 (FIG. 2) that forms the output member of the transmission assembly 18.

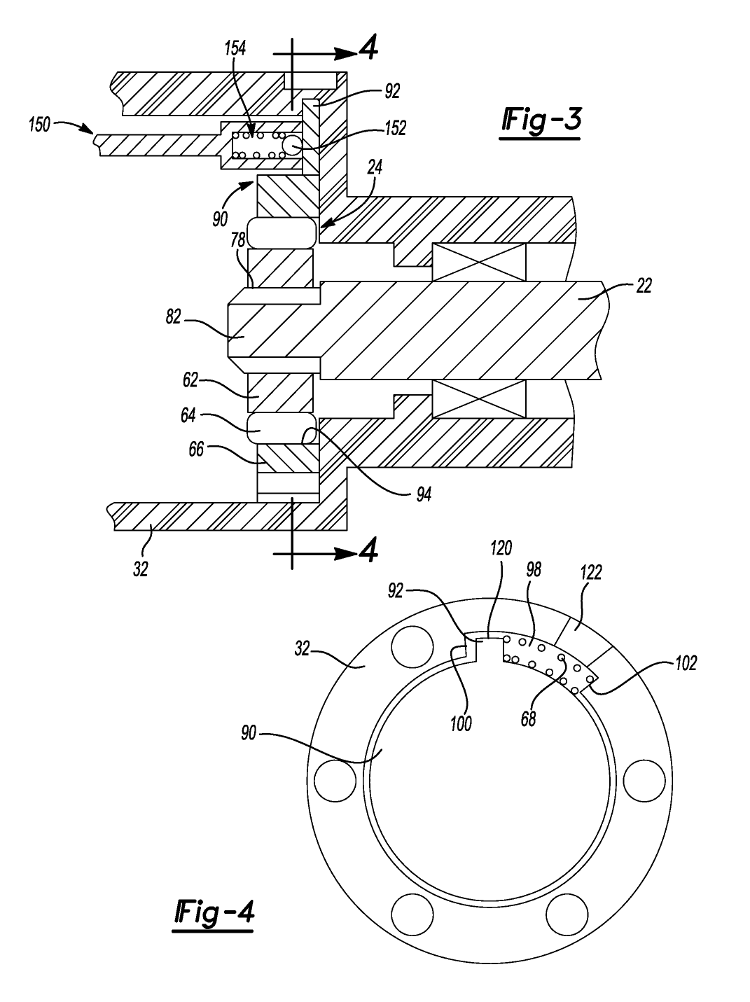

With reference to FIGS. 2-4, the spindle lock assembly 24 can include a plurality of lugs 60, an anvil 62, a plurality of pins 64, a ring structure 66, and a biasing member or return spring 68.

The lugs 60, the anvil 62 and the pins 64 can be conventional in their construction and as such, need not be described in significant detail herein. Briefly, the lugs 60, which can be circumferentially spaced apart from one another, can be coupled to and extend axially outwardly from the output planet carrier 52. The lugs 60 can define a plurality of lug or outer drive surfaces 70. The anvil 62 can define a plurality of anvil drive surfaces including a plurality of first interior drive surfaces 74, a plurality of second interior drive surfaces 76 and a central aperture 78 that can be sized to drivingly engage a mating end 82 of the output spindle 22. Each of the first interior drive surfaces 74 can be disposed opposite to (and radially inwardly of) a corresponding one of the exterior drive surfaces 70. Each of the second interior drive surfaces 76 can be disposed between an adjacent pair of the first interior drive surfaces 74. Each of the pins 64 can be received in a gap 84 between an adjacent pair of the lugs 60. Each of the pins 64 can abut an associated one of the second interior drive surfaces 76.

The ring structure 66 can be rotatably received in the gear case 32 and can have a ring body 90 and a reaction tab 92. The ring body 90 can define an aperture 94 into which the lugs 60, the anvil 62 and the pins 64 are received. The reaction tab 92 can be fixedly coupled to the ring body 90 and can be received in groove 98 (FIG. 4) in the gear case 32.

The return spring 68 can be disposed in the groove 98 in the gear case 32 and can bias the reaction tab 92 in a predetermined first rotational direction toward a first end 100 of the groove 98 opposite the return spring 68.

When the motor assembly 14 (FIG. 1) is operated to drive the output spindle 22 via the transmission assembly 18, it will be appreciated that rotation of the output planet carrier 52 will drive the anvil 62 (through contact between the exterior and first interior drive surfaces 70 and 74) to thereby rotate the output spindle 22. When the output spindle 22 is rotated relative to the output planet carrier 52 in a second rotational direction opposite the predetermined first rotational direction (i.e., in a manner that would back-drive the transmission assembly 18 in the predetermined direction), the anvil 62 can rotate relative to the lugs 60 such that the second interior drive surfaces 76 engage the pins 64 against the ring body 90. Continued rotation of the output spindle 22 in the second rotational direction can rotate the ring structure 66 about the output spindle 22 such that the reaction tab 92 compresses the return spring 68 against a second, opposite end 102 of the groove 98. It will be appreciated that a means may be employed to limit rotation of the ring structure 66 in the second rotational direction, such as a stop or compressing the return spring 68 to a maximum amount (e.g., coil-to-coil contact where a helical coil compression spring is employed as the return spring). When rotation of the ring structure 66 in the second rotational direction has been halted (i.e., so that the ring structure 66 will not rotate further in the second rotational direction relative to the gear case 32), the spindle lock assembly 24 will inhibit further rotation of the output spindle 22 in the second rotational direction. In this regard, the second interior drive surfaces 76 drive the pins 64 against the (now stationary) ring body 90 to inhibit further rotation of the anvil 62 and the output spindle 22.

In instances where a keyless chuck 110 (FIG. 1) is coupled to the output spindle 22, the spindle lock assembly 24 can be employed to provide feedback to a user of the tool 10 that the keyless chuck 110 (FIG. 1) has been sufficiently tightened. Accordingly, it will be appreciated that the “second rotational direction” can be the rotational direction in which the keyless chuck 110 (FIG. 1) is rotated to tighten the jaws (not shown) of the keyless chuck 110 (FIG. 1) to a tool bit (not shown). Moreover, the return spring 68 can provide a predetermined amount of resistance to the rotation of the ring structure 66 such that a predetermined amount of resistance to the rotation of the ring structure 66 such that a predetermined tightening torque is applied through the keyless chuck 110 (FIG. 1) to tighten the jaws (not shown) of the keyless chuck 110 (FIG. 1) against a tool bit (not shown) when the ring structure 66 has been rotated in the second rotational direction to its maximum amount.

If desired, the ring structure 66 could include an indicator 120 that is employed to produce or aid in producing a signal to the user of the tool 10 that a predetermined tightening torque has been applied through the keyless chuck 110 (FIG. 1). In one embodiment, the indicator 120 is formed on a distal end of the reaction tab 92 and extends into a window 122 in the gear case 32 when the ring structure 66 has been rotated in the second rotational direction to its maximum amount. Alternatively, the indicator 120 could be a portion of the reaction tab 92 that is employed to switch the state of a sensor. The sensor could be a proximity sensor, a limit switch, an optical sensor and/or a proximity switch.

Optionally, the tool 10 can include a braking means 150 for applying a torque to the ring structure 66 to inhibit rotation of the ring structure 66 relative to the gear case 32. In the example provided, the braking means comprises a brake element 152 that is biased into frictional engagement with the ring structure 66 via a brake spring 154. If desired, a force exerted by the brake spring 154 onto the brake element 152 can be adjustable.

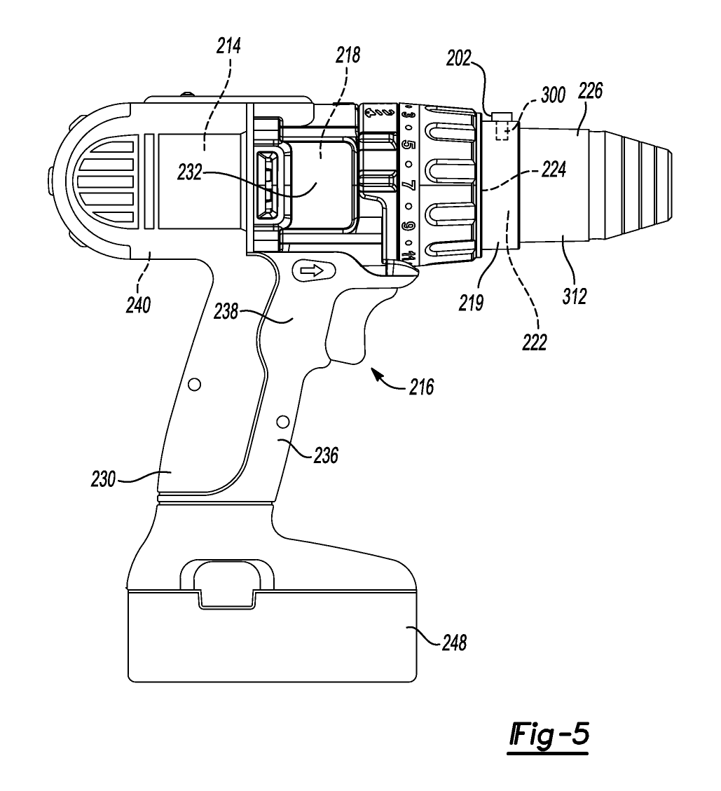

With reference to FIG. 5, an exemplary hand-held power tool constructed in accordance with additional teachings of the present disclosure is shown and generally identified at reference numeral 210. The tool 210 can include a housing assembly 212, a motor assembly 214, a trigger assembly 216, a transmission assembly 218, a transmission housing nose cover 219, a clutch assembly 220, an output spindle 222, a spindle lock assembly 224, and a chuck sleeve 226.

The housing assembly 212 can comprise a pair of handle housing shells 230 and a gear case 232 that can be removably coupled to the handle housing shells 230 via a plurality of threaded fasteners (not shown). The handle housing shells 230 can cooperate to define a handle 236, a trigger mount 238, and a cavity 240 into which the motor assembly 214 can be received.

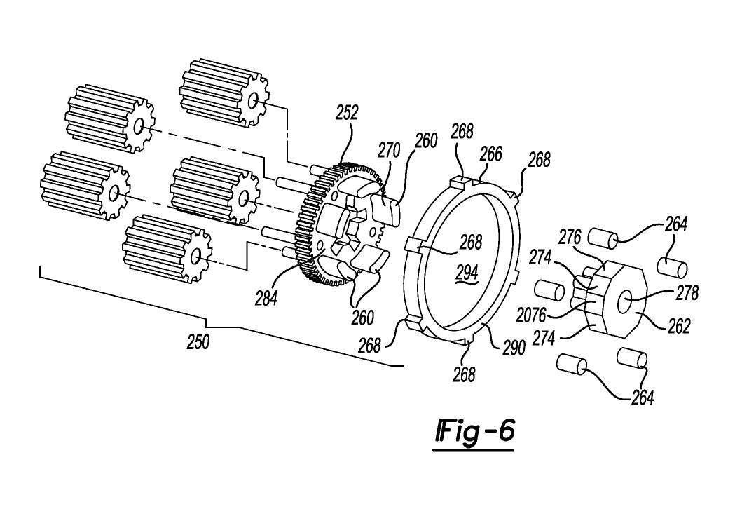

The motor assembly 214, the trigger assembly 216, and the clutch assembly 220 can be conventional in their construction and operation. In brief, the motor assembly 214 can provide rotary power to the transmission assembly 218 which can perform a speed reduction and torque multiplication function, and can output rotary power to the output spindle 222. It will be appreciated that the transmission assembly 218 could be a multi-speed transmission that is selectively operable in two or more overall gear reduction ratios. The trigger assembly 216 can be mounted to the trigger mount 238 and can be employed to selectively couple the motor assembly 214 to a source of power, such as a battery pack 248. The clutch assembly 220 can be employed to limit the magnitude of the torque that is transmitted to the output spindle 222. In the particular example provided, the transmission assembly 218 comprises an output planetary stage 250 (partially shown in FIG. 6) having an output planet carrier 252 (FIG. 6) that forms the output member of the transmission assembly 218. The spindle lock assembly 224 can include a plurality of lugs 260, an anvil 262, a plurality of pins 264, and a lock ring 266. The lock ring 266 can include a plurality of spokes 268 radially extending therefrom. As will become appreciated from the following discussion, the spokes 268 are configured to cooperate with various mechanical detents that selectively engage as a user tightens the chuck sleeve 226. The detents are configured to provide a slight angular movement of the lock ring 266 after a predetermined torque limit is reached, and then return the lock ring 266 to a home position as the user releases their grip on the chuck sleeve 226.

The lugs 260, the anvil 262, and the plurality of pins 264 can be conventional in their construction and as such, need not be described in significant detail herein. Briefly, the lugs 260, which can be circumferentially spaced apart from one another, can be coupled to and extend axially outwardly from the output planet carrier 252. The lugs 260 can define a plurality of outer drive surfaces 270. The anvil 262 can define a plurality of first interior drive surfaces 274, a plurality of second interior drive surfaces 276, and a central aperture 278 that can be sized to drivingly engage a mating end 282 of the output spindle 222. Each of the first interior drive surfaces 274 can be disposed opposite to (and radially inwardly of) a corresponding one of the exterior drive surfaces 270. Each of the second interior drive surfaces 276 can be disposed between an adjacent pair of the first interior drive surfaces 274. Each of the pins 264 can be received in a gap 284 located between an adjacent pair of the lugs 260. Each of the pins 264 can abut an associated one of the second interior drive surfaces 276.

The lock ring 266 can be rotatably received in the gear case 232 (FIG. 5) and can have a lock ring body 290 from which the spokes 268 extend from. The lock ring body 290 can define an aperture 294 into which the lugs 260, the anvil 262, and the pins 264 are received. At least one of the spokes 268 can cooperate with an extended tab 300 or indicator that can protrude through an opening 302 defined through the transmission housing nose cover 219. The extended tab 300 can move in response to the appropriate torque being reached by the lock ring 266. The position of the extended tab 300 can convey to the user that the desired torque has been reached.

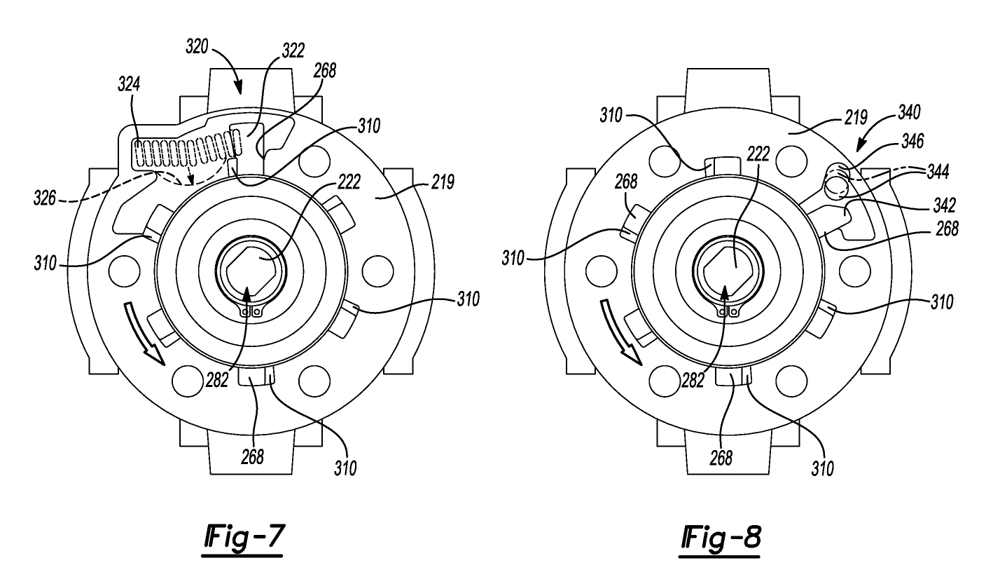

With specific reference now to FIG. 7, additional features of the transmission housing nose cover 219 will be described. The transmission housing nose cover 219 defines a corresponding plurality of grooves 310 configured to receive the spokes 268 of the lock ring 266. The grooves 310 have a radial dimension greater than the spokes 268 such that the spokes 268 are permitted to rotate radially a predetermined distance within the corresponding grooves 310 during tightening of the chuck as will be described.

When the motor assembly 214 (FIG. 5) is operated to drive the output spindle 222 via the transmission assembly 218, it will be appreciated that rotation of the output planet carrier 252 will drive the anvil 262 (through contact between exterior and first interior drive surfaces 270 and 274) to thereby rotate the output spindle 222. When the output spindle 222 is rotated relative to the output planet carrier 252 in a second rotational direction, opposite the predetermined first rotational direction (i.e., in a manner that would back-drive the transmission assembly 218 in the predetermined direction), the anvil 262 can rotate relative to the lugs 260 such that the second interior drive surfaces 276 engage the pins 264 against the lock ring body 290. Continued rotation of the output spindle 222 in the second rotational direction can rotate the lock ring 266 about the output spindle 222 such that the spokes 268 engage one of the various mechanical detents described herein whereby, upon sufficient amount of torque, the spokes 268 will deflect or otherwise move the mechanical detent. The spokes 268 are then permitted to rotate further counterclockwise (as viewed in FIG. 7) into the corresponding grooves 310.

Feedback from the mechanical detents will convey to the user that sufficient torque has been applied. It will be appreciated that a means may be employed to limit rotation of the lock ring 266 in the second rotational direction, such as a stop or compressing of a spring to a maximum amount (e.g., coil-to-coil contact where a helical coil compression spring is employed as a return spring). When rotation of the lock ring 266 in the second rotational direction has been halted (i.e., so that the lock ring 266 will not rotate further in the second rotational direction relative to the gear case 232), the spindle lock assembly 224 will inhibit further rotation of the output spindle 222 in the second rotational direction. In this regard, the second interior drive surfaces 276 drive the pins 264 against the (now stationary) lock ring body 290 to inhibit further rotation of the anvil 262 and the output spindle 222.

In instances where a keyless chuck 312 is coupled to the output spindle 222, the spindle lock assembly 224 can be employed to provide feedback to a user of the tool 210 that the keyless chuck 312 has been sufficiently tightened. Accordingly, it will be appreciated that the “second rotational direction” can be the rotational direction in which the keyless chuck 312 is rotated to tighten the jaws (not shown) of the keyless chuck 312 to a tool bit (not shown). Moreover, the structure provided by the various mechanical detents described herein can provide a predetermined amount of resistance to the motion of the lock ring 266 such that a predetermined tightening torque is applied through the keyless chuck 312 to tighten the jaws (not shown) of the keyless chuck 312 against a tool bit (not shown) when the lock ring 266 has been rotated in the second rotational direction to its maximum amount.

As identified above, in some examples, an indicator 300 can be employed to produce a visual signal to the user of the tool 210 that a predetermined tightening torque has been applied through the keyless chuck 312. In the example shown, the indicator 300 cooperates with one of the spokes 268 on the lock ring 266 and extends through an opening 302 on the gear case 232 when the lock ring 266 has been rotated in the second rotational direction to its maximum amount. Additionally or alternatively, the indicator 300 could be a portion of one of the spokes 268 that is employed to switch the state of a sensor. The sensor could be a proximity sensor, a limit switch, an optical sensor, and/or a proximity switch.

With reference now to FIG. 7, a mechanical detent 320 constructed in accordance to one example of the present teachings will be described. The mechanical detent 320 generally comprises an extension 322 provided on one of the spokes 268 that engages a coil spring 324 that is fixed at an opposite end to the transmission housing nose cover 219. The extension 322 can be configured to provide a force onto the spring 324 until a point at which the spring 324 buckles and moves to a deflected position identified at reference 326. The buckling condition will give an audible indication and sharp transition that includes a “snap” motion that is clear to the user that sufficient torque has been reached. When the user releases the chuck sleeve 226, the spokes 268 are permitted to rotate in a direction clockwise as viewed from FIG. 7 and return to their original position.

Turning now to FIG. 8, a mechanical detent 340 constructed in accordance to additional features of the present teachings will be described. The mechanical detent 340 includes a cam 342 incorporated on one of the spokes 268 that is configured to push on a metal roller 344 to force the roller 344 past a detent pocket 346 (see metal roller 344 shown in phantom) configured within the transmission housing nose cover 219. The transmission housing nose cover 219 is used as a spring element in the configuration shown in FIG. 8. Again, once a user releases grip from the chuck sleeve 226, the lock ring 266 is permitted to rotate in a direction clockwise as viewed from FIG. 8 and return to its original position.

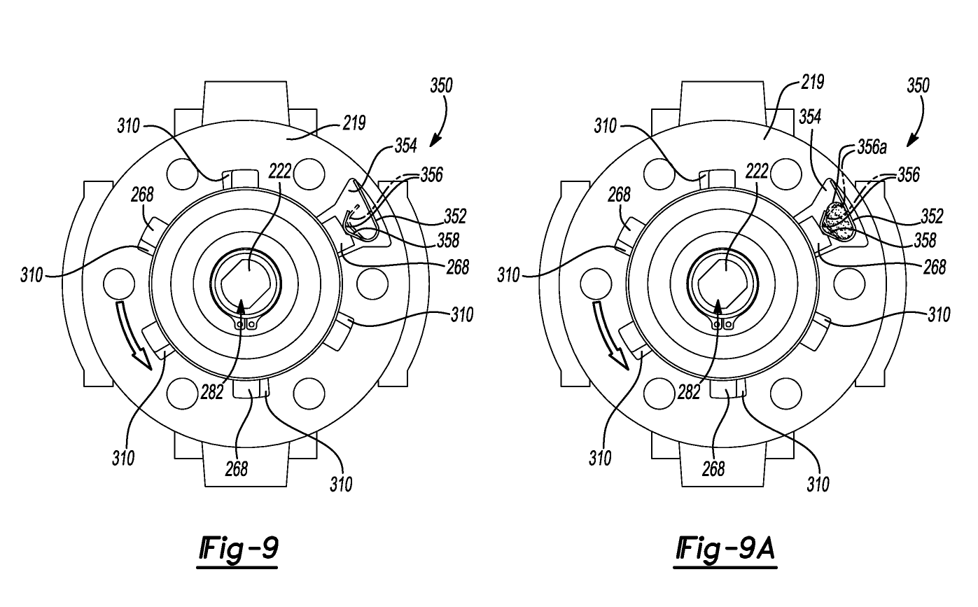

Turning now to FIG. 9, a mechanical detent 350 constructed in accordance to additional features of the present teachings is shown. The mechanical detent 350 can generally include a “C-shaped” leaf spring 352 disposed within a pocket 354 of the transmission housing nose cover 219. The C-shaped leaf spring 352 includes an end portion 356 that is configured to nest into a spoke groove 358 formed on one of the spokes 268. Once a sufficient amount of torque has been experienced by the spring 352, the spring 352 will buckle or snap (see spring 352 shown in phantom) allowing the spokes 268 to rotate further counterclockwise, as viewed in FIG. 9, into the grooves 310 conveying to the user that sufficient torque has been reached. FIG. 9A illustrates an additional elastic element 356a incorporated inside of the spring 352. The elastic element 356a can provide additional spring force. The elastic element 356a can be formed of rubber, urethane or other similar material. The elastic element 356a may also be incorporated similarly for use with the spring 382 discussed below (FIG. 11).

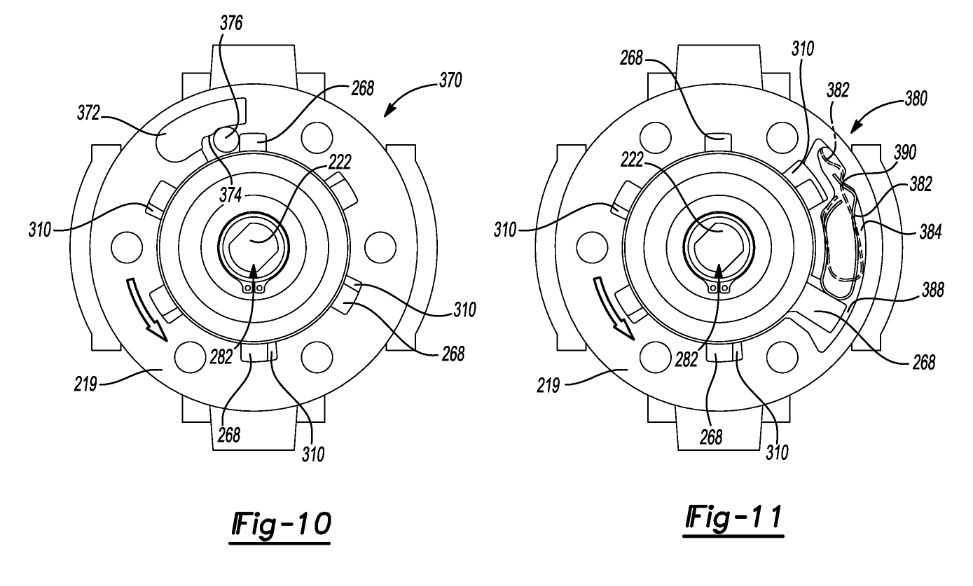

Turning now to FIG. 10, a mechanical detent 370 constructed in accordance to additional features of the present teachings is shown. The mechanical detent 370 is similar to the configuration of the mechanical detent 340 set forth in FIG. 8, but uses an additional metal component 372 that incorporates a detent bump 374 that is configured to bear against a steel roller 376 driven by the spoke 268 of the lock ring 266. The component 372 will act to spread the stresses more evenly on the transmission housing nose cover 219 to inhibit wear and fracture such as when the transmission housing nose cover 19 is formed of plastic.

With reference to FIG. 11, a mechanical detent 380 constructed in accordance to other features of the present disclosure is shown. The mechanical detent 380 generally includes a leaf spring 382 that is received in a pocket 384 formed in the transmission housing nose cover 219. The spring 382 can be urged by an extension portion 388 formed on one of the spokes 268 in a direction counterclockwise as viewed from FIG. 11 during tightening of the chuck sleeve 226. Movement of the spring 382 in a direction counterclockwise within the pocket 384 will cause the spring 382 to ride over a detent bump 390 extending from the transmission housing nose cover 219 causing the spring 382 to collapse upon itself (shown in phantom) and increase in stiffness to give a high force or torque capability feedback onto the spoke 268. In this regard, it is conveyed to a user that sufficient torque has been reached. Upon release of the chuck sleeve 226, the spokes 268 are permitted to rotate in a direction clockwise as viewed from FIG. 11 within the grooves 310 to their original position.

It will be appreciated that the above description is merely exemplary in nature and is not intended to limit the present disclosure, its application or uses. While specific example have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A hand-held power tool comprising:
a housing including a gear case;
a motor assembly disposed in the housing and configured to output rotary power to an output spindle;
a spindle lock assembly including:
an anvil matingly engaged to the output spindle;
a ring structure rotatably received in the gear case and having a ring body and a reaction tab; and
a biasing member disposed in the gear case and configured to bias the reaction tab in a first predetermined rotational direction;
wherein rotation of the output spindle in a second rotational direction, opposite the first rotational direction rotates the ring structure about the output spindle causing the reaction tab to compress the biasing member wherein the spindle lock assembly inhibits further rotation of the output spindle in the second rotational direction.

2. The hand-held power tool of claim 1, further comprising an output planet carrier that forms an output member of a transmission assembly, the transmission assembly selectively coupled between the motor assembly and the output spindle.

3. The hand-held power tool of claim 1 wherein the spindle lock assembly further comprises a plurality of lugs coupled to and extending axially and outwardly from the output planet carrier.

4. The hand-held power tool of claim 3 wherein the lugs of the plurality of lugs define a plurality of lug drive surfaces and wherein the anvil defines a plurality of anvil drive surfaces, each of the lug drive surfaces disposed adjacent to an anvil drive surface.

5. The hand-held power tool of claim 4, further comprising a plurality of pins received in a corresponding gap defined between adjacent anvil drive surfaces.

6. The hand-held power tool of claim 1 wherein the biasing member comprises a coil spring disposed in a groove defined in the gear case.

7. The hand-held power tool of claim 4 wherein rotation of the output spindle causes the anvil to rotate relative to the lugs such that the second drive surface of the anvil engages the pins against the ring body.

8. The hand-held power tool of claim 1 wherein the ring structure comprises an indicator on a distal end of the reaction tab and that extends into a window in the gear case when the ring structure has been rotated a predetermined amount.

9. The hand-held power tool of claim 1, further comprising a braking means configured to inhibit rotation of the ring structure relative to the gear case, the braking means comprising a brake element that is biased into frictional engagement with the ring structure.

10. A hand-held power tool comprising:
a housing including a gear case;
a motor assembly disposed in the housing and configured to output rotary power to an output spindle;
a nose cover defining at least one groove;
a spindle lock assembly including:
an anvil matingly engaged to the output spindle;
a ring structure rotatably received in the gear case and having a ring body and at least one spoke; and
a detent disposed in the gear case and configured to move upon rotation of the at least one spoke in a rotational direction;
wherein rotation of the output spindle in the rotational direction rotates the ring structure about the output spindle causing the at least one spoke to move the detent wherein the at least one spoke subsequently further rotates into the at least one groove.

11. The hand-held power tool of claim 10, further comprising an output planet carrier that forms an output member of a transmission assembly, the transmission assembly selectively coupled between the motor assembly and the output spindle.

12. The hand-held power tool of claim 10 wherein the spindle lock assembly further comprises a plurality of lugs coupled to and extending axially and outwardly from the output planet carrier.

13. The hand-held power tool of claim 12 wherein the lugs define a plurality of lug drive surfaces and wherein the anvil defines a plurality of anvil drive surfaces, each of the lug drive surfaces disposed adjacent to an anvil drive surface.

14. The hand-held power tool of claim 13, further comprising a plurality of pins received in a corresponding gap defined between adjacent anvil drive surfaces and wherein rotation of the output spindle causes the anvil to rotate relative to the lugs such that the second drive surface of the anvil engages the pins against the ring body.

15. The hand-held power tool of claim 10 wherein the detent comprises an extension disposed on the at least one spoke and a coil spring disposed in a groove defined in the gear case.

16. The hand-held power tool of claim 15 wherein the coil spring is configured to buckle and move into a deflected position.

17. The hand-held power tool of claim 10 wherein the detent comprises a leaf spring disposed in a pocket of the nose cover of the power tool, wherein the leaf spring is configured to buckle and move into a deflected position.

18. The hand-held power tool of claim 17 wherein the leaf spring comprises a C-shaped leaf spring having an end portion configured to nest into a spoke groove formed on the at least one spoke.

19. The hand-held power tool of claim 17 wherein the spring is configured to be urged by an extension portion formed on the at least one spoke causing the spring to ride over a detent bump extending from the nose cover causing the spring to collapse.

20. The hand-held power tool of claim 10 wherein the detent comprises a cam incorporated on the at least one spoke and configured to advance a roller past a detent pocket of the nose cover of the power tool.
